(19) United States
(12) Patent Application Publication
(10) Pub. No.: US 2024/0350836 A1
(43) Pub. Date: Oct. 24, 2024

(54) SAFETY SYSTEMS AND RESCUE SYSTEMS FOR ELEVATED WORKSITES

(71) Applicant: CV International, Inc., Bend, OR (US)

(72) Inventors: Alan Michael O'SHEA, Bend, OR (US); Logan Eyestone, Bend, OR (US)

(21) Appl. No.: 18/305,595

(22) Filed: Apr. 24, 2023

(51) Int. Cl. A62B 1/06; E04G 21/32

(52) U.S. Cl. CPC A62B 1/06; E04G 21/3223

(57) ABSTRACT

A rescue system for evacuating an incapacitated person from an elevated area includes a frame configured to be mounted on a pair of vertical posts extending upwardly from a surface of the elevated area, the posts defining a plane, wherein at least a portion of the frame is cantilevered out from the plane of the posts, and a lowering system supported by the cantilevered portion of the frame, the lowering system being configured to allow a rescuer to lower the incapacitated person by rope from the elevated area.

### BACKGROUND

Electrical transformers include elevated platforms that are accessed by workers inspecting, maintaining, and servicing the transformer. Because of the height of these transformers and the risk of injury or death due to falls, workers either use a safety harness and tether system or are protected by a railing system surrounding the edge of the transformer.

A railing system used for this purpose is disclosed in U.S. Pat. No. 10,883,275 (“the '275 patent), the entire disclosure of which is incorporated by reference herein. Referring to FIG. 1, in the system disclosed in the '275 patent a guardrail assembly 100 includes upper brace assemblies 101/102, corresponding lower brace assemblies 104/106, and, at the center of each brace assembly, a midrail clamp assembly 103. Each set of upper and lower brace assemblies with their corresponding midrail clamp assembly 103 are secured between a pair of vertical post assemblies 108 which are attached to the top surface of the transformer. The post anchors (two center anchors 105 and four corner anchors 107) provide the interface between the top surface edge of the transformer and each vertical post assembly 108.

While the system shown in FIG. 1 is effective in preventing falls and is easily mounted on the transformer platform, it does not provide for easy evacuation from the elevated surface of an incapacitated worker or a worker otherwise in need of quick evacuation. Typically, a jib crane is required in order to evacuate a worker who is unable to climb down from the transformer using a ladder.

Other elevated worksites, e.g., silos, smokestacks, and tanks accessed by ladders, would also benefit from a readily deployable evacuation system.

### SUMMARY

The present specification discloses a rescue system for evacuating a person from an elevated area in an industrial setting, for example the upper surface of a transformer, utilizing a cantilevered winch/pulley system. In some implementations the rescue system is integrated with a railing system similar to the systems discussed above to form a safety system.

While the systems disclosed herein are designed to meet the exacting standards required for lowering a person, they are also useful for lowering inanimate objects such as equipment.

In one aspect, the disclosure features a rescue system for evacuating an incapacitated person from an elevated area, the system comprising a frame configured to be mounted on a pair of vertical posts extending upwardly from a surface of the elevated area, the posts defining a plane, wherein at least a portion of the frame is cantilevered out from the plane of the posts, and a lowering system supported by the cantilevered portion of the frame, the lowering system being configured to allow a rescuer to lower the incapacitated person by rope from the elevated area.

Some implementations include one or more of the following features. The rescue system may include a pair of frame tension lines each having a first end configured to be attached to the frame at an upper end of the vertical posts and a second end configured to be anchored to the surface of the elevated area. The lowering system may include a rope having a first end configured to be fixedly attached to the frame. The lowering system may include a winch. The frame may include a horizontal assembly, a first end of which is mounted at upper ends of the vertical posts and a second, opposite end of which is cantilevered out therefrom, and a pair of diagonal members that extend from corners of the second end to lower ends of the vertical posts. The lowering system may further include a plurality of pulley carabiners. The frame may be constructed of non-conductive material. Lower ends of the posts may be removably mounted in anchors secured to the surface of the elevated area. The frame may comprise a plurality of members that are detachably joined to each other.

In another aspect, the disclosure features a safety system for use in an elevated work area, the safety system comprising: (a) a railing system comprising: (i) a plurality of posts anchored to a surface of the elevated work area; (ii) a plurality of rails extending between the posts to define a guard rail assembly; and (iii) a sliding gate in the guard rail assembly providing, when open, an open area for access to the elevated work area from below; and (b) a rescue system comprising: (i) a frame configured to be mounted on a pair of vertical posts extending upwardly from a surface of the elevated area, the posts defining a plane, wherein at least a portion of the frame is cantilevered out from the plane of the posts, and (ii) a lowering system supported by the cantilevered portion of the frame, the lowering system being configured to allow a rescuer to lower the incapacitated person by rope from the elevated area.

In some implementations, the safety system may include one or more of the following features. The sliding gate may include a pair of horizontal cylindrical sliding members that are telescopically mounted in cylindrical sheath members. The rescue system may further comprise anchors secured to the elevated work area, each anchor comprising a base plate, an elongated socket extending upwardly from the base plate, and a flange extending laterally from the socket. The socket may be dimensioned to receive the lower end of one of the vertical posts of the rescue system and include a through bore configured to receive a pin to secure the post in the socket. The flange may include a bore configured to allow mounting of the diagonal members of the frame to the anchor.

In a further aspect, the invention features a method of evacuating a person from an elevated work area, the method comprising (a) deploying a rescue system that includes a frame having a portion that is cantilevered out from an edge of the work area and defines an opening through which the person can pass, and a lowering system supported by the cantilevered portion of the frame, (b) securing the person to a portion of the lowering system; and (c) utilizing the lowering system to lower the person from the elevated work area.

In some implementations the method may include one or more of the following steps. Utilizing the lowering system may include operating a winch that forms part of the lowering system. Deploying the rescue system may include anchoring the frame to a surface of the elevated work area, e.g., by attaching the frame to anchors that have been pre-installed on the surface prior to the evacuation. The opening may be in a railing system that is disposed along the edge of the work area, the opening may be normally closed by a sliding gate, and the method may further comprise the step of opening the sliding gate. Utilizing the lowering system may include feeding a rope attached to the person through a double fall pulley mechanism.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of a prior art railing system in place atop a cutaway portion of an electrical transformer.

FIG. 2 is a perspective view of a safety system according to one implementation, including a rescue system installed on a railing system designed for use with the rescue system, with a dummy representing a person being rescued.

FIG. 2A is an enlarged perspective view of the rescue system and dummy shown in FIG. 2, taken from a different angle.

FIG. 3 is a perspective view of the rescue system in isolation.

FIG. 3A is a perspective view of the rescue system of FIG. 3 taken from the left side.

FIG. 4 is an enlarged detail view of area A in FIG. 3.

FIG. 5 is an enlarged detail view of area B in FIG. 3.

FIG. 6 is an enlarged detail view of area C in FIG. 3.

FIG. 7 is a perspective view of an anchor for the rescue system posts according to one implementation.

FIG. 8A is a perspective view showing a first step of installation of the anchor 22A.

FIG. 8B is a perspective view showing a second step of installation of the anchor 22A.

FIG. 8C is a perspective view showing a third step of installation of the anchor 22A.

FIG. 8D is a perspective view showing a final step of installation of the anchor 22A.

FIG. 9 is a detail view of the winch and the winch anchor.

FIG. 10 is a perspective view of a sliding gate portion of the railing system in a closed position.

FIG. 10A is a perspective view of the gate in an open position.

FIG. 11 is a perspective view of the rescue system in a disassembled state, with the rope, winch and carabiners omitted.

FIG. 12 is a perspective view of a railing post anchor according to one implementation.

FIG. 13 is a side plan view of the railing post anchor of FIG. 12.

### DETAILED DESCRIPTION

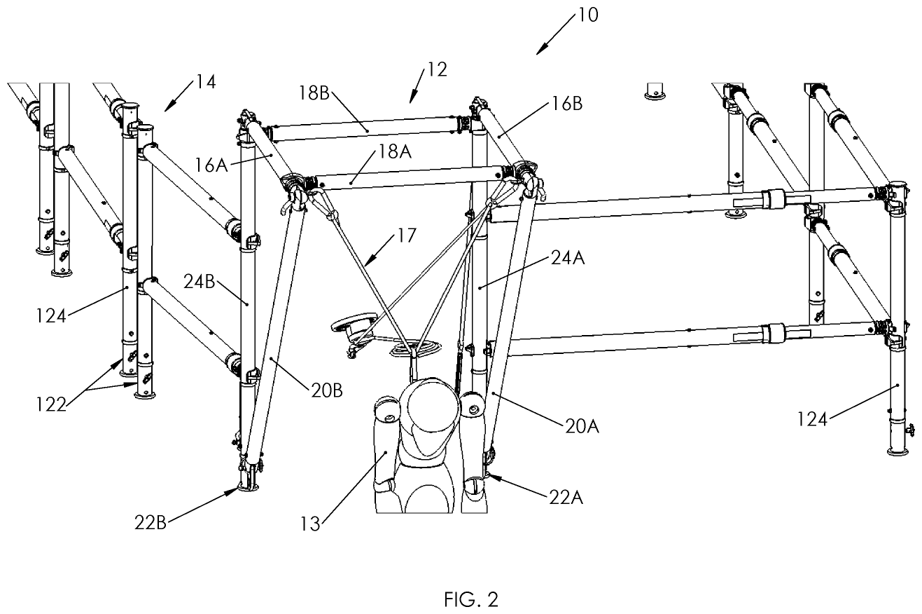

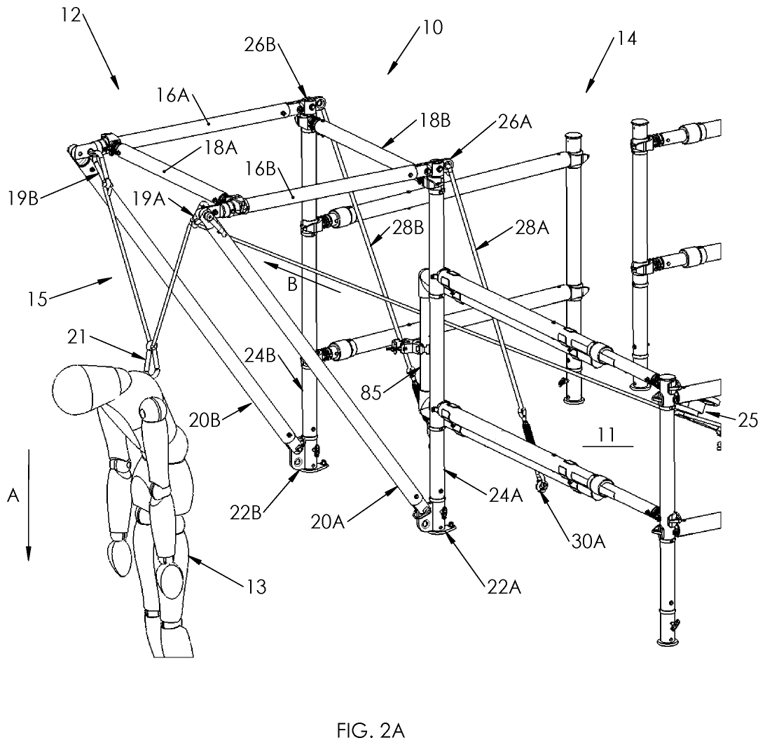

Referring to FIGS. 2 and 2A, a safety system 10 includes a rescue system 12 and a railing system 14. The rescue system 12 is adapted to be readily transportable, and to be quickly deployed and easily and securely mounted on the railing system when a rescue is needed, as will be discussed further below. During normal operations at the transformer site the rescue system 12 may be folded up and stored, e.g., in a bag or case.

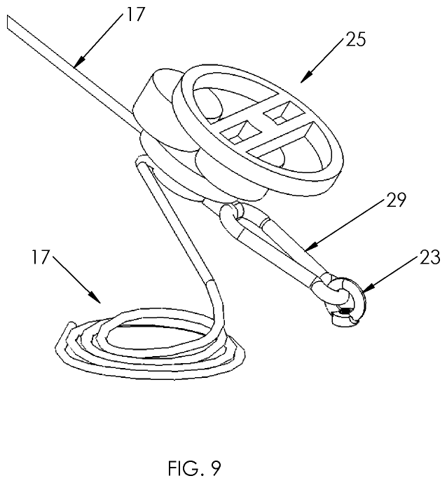

The rescue system 12 includes a frame that is supported by and cantilevered out from the railing system 14, the details of which will be discussed below. The frame supports a winch/pulley lowering system 15, which includes a rope 17, a pair of mounting carabiners 19A, 19B, a rescue carabiner 21, and a winch 25. Because it is cantilevered out from the railing system, the frame defines an area, spaced from the side of the transformer, into which a person in need of evacuation (represented by dummy 13 in FIGS. 2 and 2A) can be safely moved allowing the person to be lowered from the transformer without contacting the side wall of the transformer. In some implementations, the frame extends less than 7 feet above the transformer surface 11, preferably 5 feet or less, to comply with height restrictions imposed by overhead wires. The rope 17 passes through carabiner 19A and rescue carabiner 21 and is threaded through the winch 25 which allows the person to be lowered slowly and safely, even if the weight of the person far exceeds that of the rescuer. The winch 25 is attached, e.g., by a carabiner 29, to an anchor 23 that is welded to the transformer surface 11, as shown in FIG. 9. Details and use of the lowering system 15 will be discussed below.

### Frame Construction

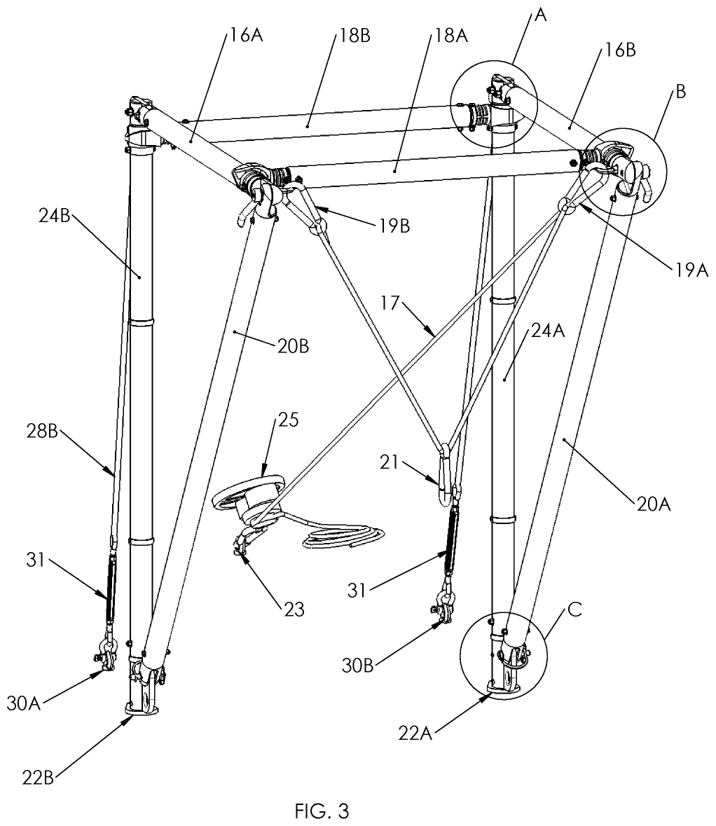

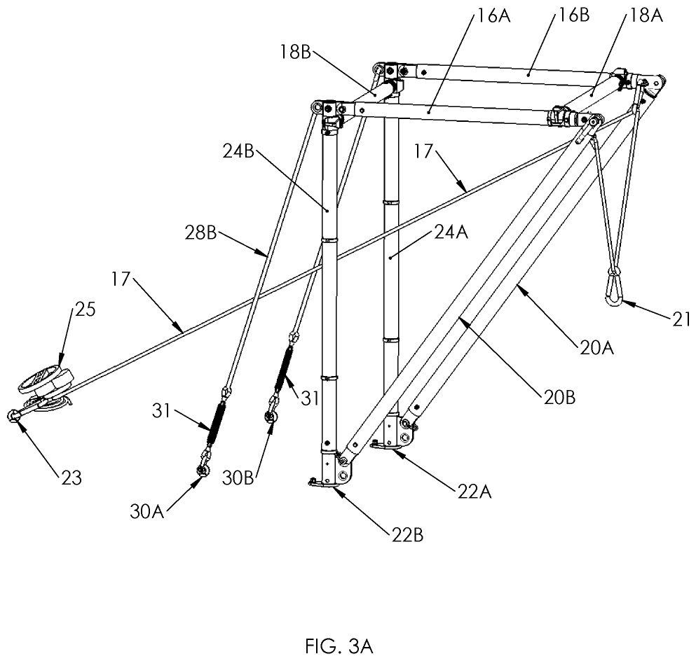

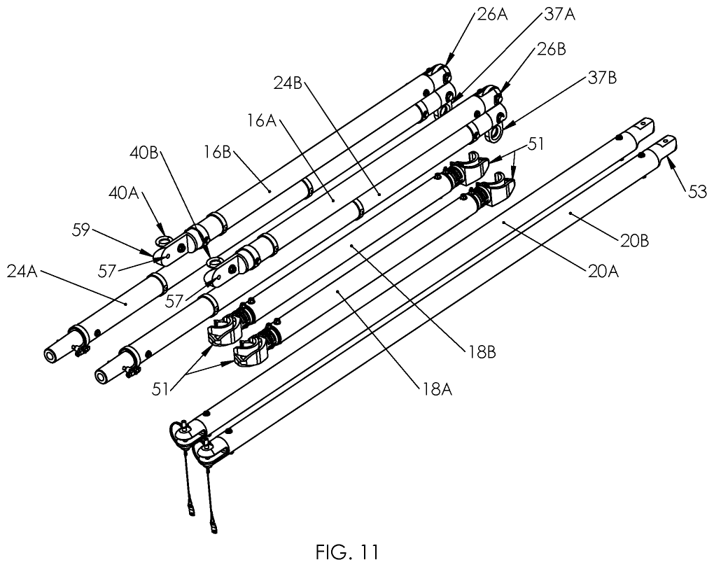

Referring to FIGS. 2-3A, the frame includes a generally square upper horizontal assembly formed of a pair of generally parallel arms 16A, 16B, that extend outwardly from the railing system 14. These arms are connected by a pair of generally parallel cross members 18A, 18B that extend generally perpendicular to the arms 16A. 16B. The cross members are removably clamped onto the arms as will be discussed below with regard to folding and deployment of the frame. Two diagonal members 20A, 20B, extend diagonally from the outer corners of the horizontal assembly (the distal ends of the arms 18A, 18B) to anchors 22A, 22B that are welded to the transformer surface 11. The structure of these anchors will be discussed in detail below. Anchors 22A, 22B, also serve as mounting points for a pair of vertical posts 24A. 24B, which are joined to the proximal ends of the arms 18A, 18B and serve as part of the railing system 14. The frame members are shown disassembled in FIG. 11 and their assembly will be discussed below.

The upper ends 26A. 26B of the posts 24A, 24B are supported by a pair of tensioning lines 28A. 28B, which are secured at one end to eyelets 37A, 37B (FIGS. 4 and 9) at ends 26A, 26B of the posts, e.g., by a shackle (not shown), and at the other end to the transformer surface 11 by welded anchors 30A, 30B. The tensioning lines 28A, 28B may be removably attached to the anchors by, for example, carabiners (not shown), and turnbuckles 31 can be used to tighten the tensioning lines after they are attached to the anchors.

Thus, the load to be lowered by the lowering system is distributed over five anchors, i.e., anchors 22A, 22B, 23, 30A and 30B, each of which is securely mounted on the transformer surface 11. As a result of this arrangement, all of the vertical and diagonal members of the frame are in compression and thus do not need to be formed of a very high strength material. (The horizontally extending arms 16A. 16B and cross-members 18A, 18B are not in compression; however, these members carry very little load and are included primarily to provide racking stability.) This force distribution allows the frame to be formed of a lightweight rigid material such as fiberglass, facilitating transport and deployment of the frame. The use of fiberglass is also preferred for systems to be used on transformers and other electrical facilities due to its non-conductive nature. The five secure anchor points also allow the system to be rated to safely lower heavy persons, for example to lower up to 300 pounds, or even up to 500 pounds. In some implementations the failure load will be 1000 lbs or greater, e.g., 1200 lbs.

### Lowering System

Referring to FIG. 3, the lowering system 15 includes a rope 17 one end of which is fixedly attached to the frame via carabiner 19B when the system is deployed. The rope 17 is a Kernmantle static line that is fixedly attached at its distal end to carabiner 19B, e.g., by a permanent loop.

The rope is threaded through the carabiner 19A and the winch 25 and the free end is piled on the transformer surface 11. Carabiners 19A and 19B are attached to the frame by clipping them through eyelets 40A and 40B, respectively, which are bolted to the distal ends of arms 16B and 16A. Eyelets 40A/40B can be seen best in FIG. 11.

The person to be lowered is attached to the system using the rescue carabiner 21 which is clipped into a harness (e.g., a chest harness, not shown) on the incapacitated person (dummy 13, FIGS. 2-2A). The rescuer then lowers the person by feeding the rope 17 through the winch 25 so that the rope slides through the carabiner 19A (arrow B, FIG. 2A) allowing the rescue carabiner 21 (and thus the person attached to the carabiner 21) to travel down the rope 17 as the V formed by the three carabiners extends downwardly (arrow A, FIG. 2A). This lowering technique, referred to as a double fall pulley system, is desirable in that it prevents the person being lowered from spinning or swinging on the rope.

Preferably the carabiners through which the rope is fed during lowering (carabiner 19A and rescue carabiner 21) are pulley carabiners, to allow smooth lowering and prevent damage to the rope. It is also preferred that these carabiners be locking carabiners for safety.

In some implementations carabiner 19B is a snap hook having an eyelet through which the fixed end of the rope is permanently threaded. The rope may be a “rope with end loops” in which a permanent loop is formed at the end of the rope by stitching that is protected by a plastic sleeve, as is well known in the rescue operations art.

The winch 25 is designed specifically for use in rescue situations. In some implementations the winch 25 is rated to safely lower a person (or a person and an accompanying rescuer) weighing up to 620 pounds (282 kg). Suitable winches include those that are manual and those that have an option for powered operation, e.g., using a drill.

In some cases the winch 25, rope 17, carabiner 19B (in the form of a snap hook permanently joined to rope 17), and carabiner 29, mounted on the winch 25, are supplied as an integrated unit. A rescue device of this type is commercially available from 3M™ under the tradename DBI-SALA® Rollgliss™ R550 Rescue and Descent Device 3327350. This device is designed to safely lower a person (or 2 persons together) up to 350 ft. (107 m).

### Frame Foldability and Deployment

Advantageously, the rescue system can be easily attached to the railing system during deployment for a rescue, and then easily removed and disassembled/folded for storage, if desired, after the rescue has been completed. Generally, the folded rescue system is stored on the transformer, to save time in the event of a rescue situation and is relatively small and compact to facilitate storage and transport.

If the rescue system is not stored on the transformer and needs to be carried up to the transformer on a ladder it is relatively light and easy to carry. For example, the entire rescue system, including the winch and rope, may weigh less than 100 pounds (45 kg), and in some cases even less than 75 pounds (34 kg). In some implementations the frame may weigh less than 60 pounds (27 kg), and in some cases even less than 50 pounds (23 kg).

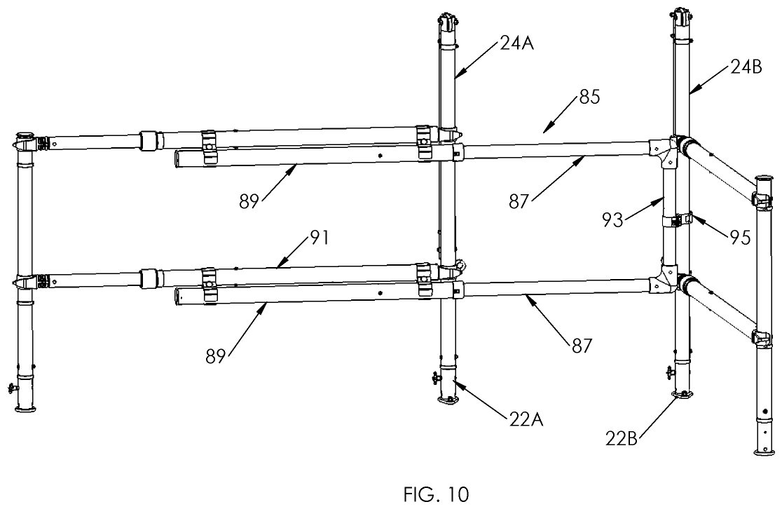

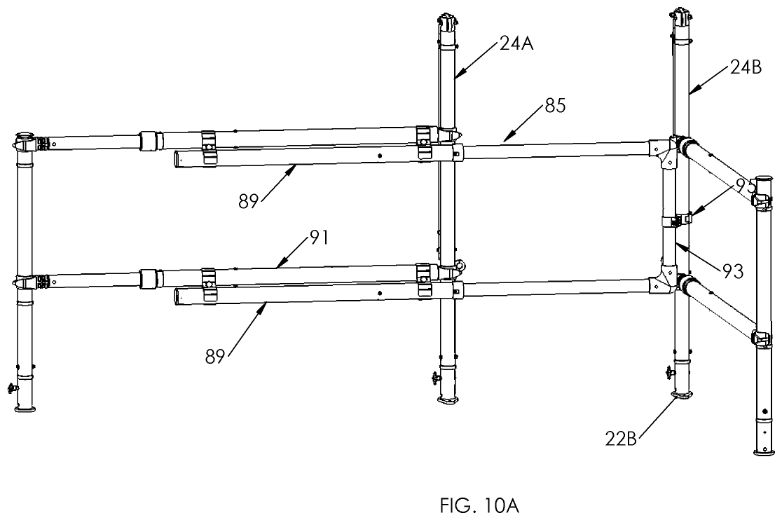

Referring to FIG. 11, when the frame of the rescue system is in a disassembled state, the arms 16A, 16B remain attached to the posts 24A, 24B, with the posts and arms being folded against each other for compactness. This is accomplished by the arms and posts being connected in a manner that allows pivoting. It is noted that if posts 24A, 24B are removed for storage of the rescue system they are replaced by railing posts 124 (FIG. 10). For more rapid deployment, the posts 24A, 24B may be left in place on the transformer surface 11, and the arms 16A, 16B folded downward against the posts.

Referring to FIG. 4, arm 16B terminates in a clevis fork 41 that is joined to a plate 43 by a bolt 45 which can be loosened to fold the arm 16B and post 24A towards each other. The plate 43 is secured to a clevis fork 47 at the end of post 24A by a bolt 49.

As shown in FIGS. 4 and 5, the cross-members 18A, 18B are removably attached to the arms 16A, 16B by clamps 51. These clamps, which are commercially available for use with scaffolding, are configured to be quickly applied and closed during deployment of the system in an emergency, and easily opened for disassembly of the frame after use. They can be secured and disassembled without the use of any tools.

Referring to FIG. 5, one end of each of the diagonal members 20A, 20B is removably attached to a corresponding end of each of the arms 16B, 16A, respectively, by a lap joint 53 having a bolt/handle nut assembly 55 that is inserted into a receiving bore 57 (FIG. 11) in a corresponding, facing lap joint 59 on the end of the arm 16B or 16A.

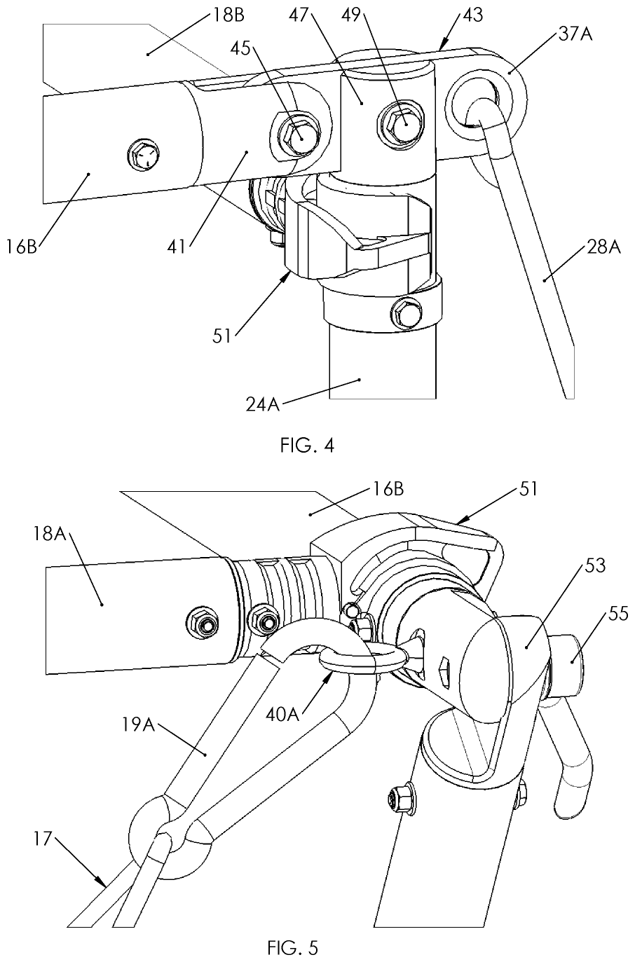

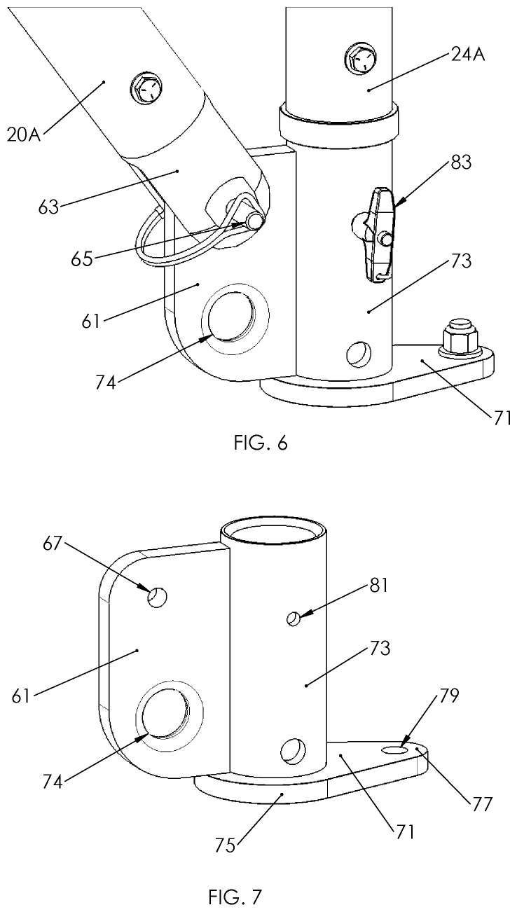

Referring to FIG. 6, the diagonal members 20A, 20B are attached at their opposite ends to the anchors 22A, 22B, by insertion of a flange 61 of the anchor into a clevis fork 63 of the diagonal member (shown also in FIG. 11). The flange 61 is secured in place in the clevis fork 63 by a wire-lock clevis pin 65 that is inserted into a receiving bore 67 (FIG. 7) on the flange 61.

Together, these various easily detachable or foldable connections allow the frame to be easily deployed for a rescue and easily broken down and stored after the rescue has been completed.

If an integrated rescue winch device is used, which includes the rope 17 pre-threaded through the winch 25 as well as the other parts of the lowering system, as discussed above, the lowering system can be quickly and easily removed as a single unit. The lowering system can be stored separately or with the components of the frame. The tensioning lines 28A/28B and associated hardware (turnbuckles, carabiners) can also be easily removed and conveniently stored, generally with the frame components so that everything is ready for rapid deployment.

### Anchor Construction

While various types of anchors may be used to attach the rescue system 11 to the transformer surface 11, in the preferred implementation shown the anchors 22A and 22B are configured to removably receive the ends of the diagonal members 20A. 20B, and also to allow the standard railing posts 124 to be easily replaced by posts 24A, 24B during deployment. These anchors are configured to facilitate rapid deployment of the rescue system during an emergency.

Referring to FIG. 7, anchor 22A includes a base plate 71, an elongated socket 73 welded to and extending upwardly from the base plate 71, and flange 61, discussed above, extending laterally from the socket 73. The base plate 71 is generally pear-shaped, having a wider end 75 to support the socket and a narrower end 77 that includes a bore 79. The pear shape reduces weight and material use; other shapes may be utilized. The socket is dimensioned to receive the lower end of one of the posts 24A, 24B, and includes a through bore 81 configured to receive a pin 83 (FIG. 3), e.g., a clevis pin or the like, to secure the post in the socket. The flange 61 is configured to allow mounting of the diagonal members of the frame, as discussed above, via bore 67. A larger bore 74 is provided below bore 67 to provide a tie off option during installation. The bore 74 is optional and may be omitted if desired.

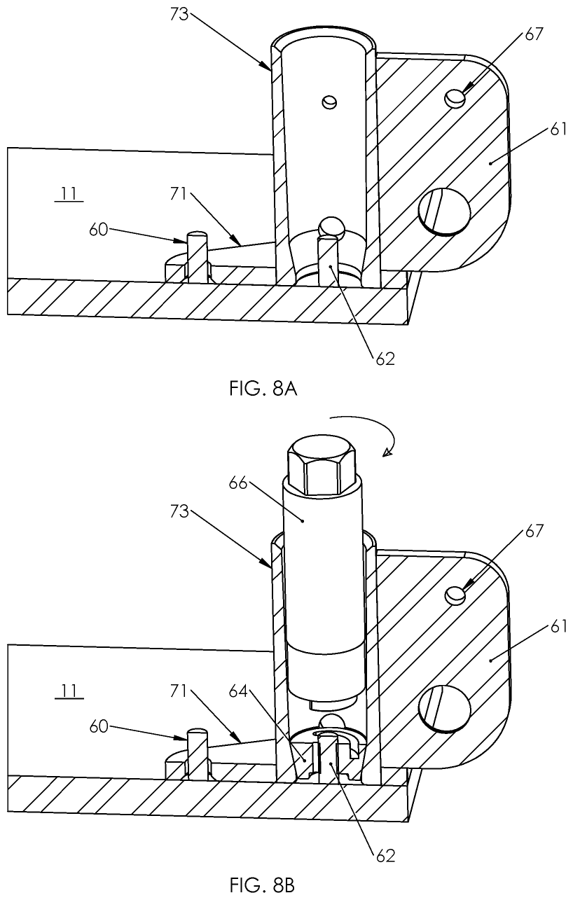

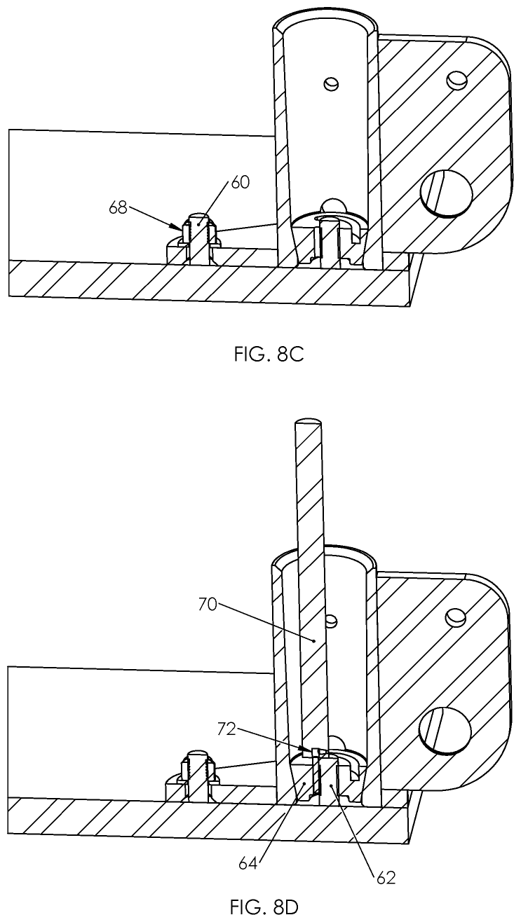

The installation of anchors 22A/22B is shown in FIGS. 8A-8B. (It is noted that this installation is performed at the time of initial installation of the railing system 14, with the anchors 22A/22B being used to support normal railing posts when the rescue system is not in use.)

Prior to the step shown in FIG. 8A, two studs 60, 62 are stud welded to the transformer surface 11. At the start of installation (FIG. 8A), the operator places the base plate 71 over the studs, with stud 60 extending through bore 79 and stud 62 extending into the socket 73. Next, a taper nut 64 is placed in the base of socket 73, surrounding stud 62, and turned using an appropriate tool 66, securing the socket to the stud (FIG. 8B). A washer and a nylon insert lock nut 68 are then applied to the stud 60 (FIG. 8C). Finally, a pin driver 70 and hammer (not shown) are used to install a staking pin 72 into a threaded interference hole in the taper nut 64 (FIG. 8D).

As discussed above, the rescue system includes, as anchor points, three additional anchors, i.e., anchors 23, 30A, and 30B. These anchors are generally simple ring anchors that are welded to the transformer surface 11 to allow easy attachment of carabiners and similar clipping devices.

### Railing System

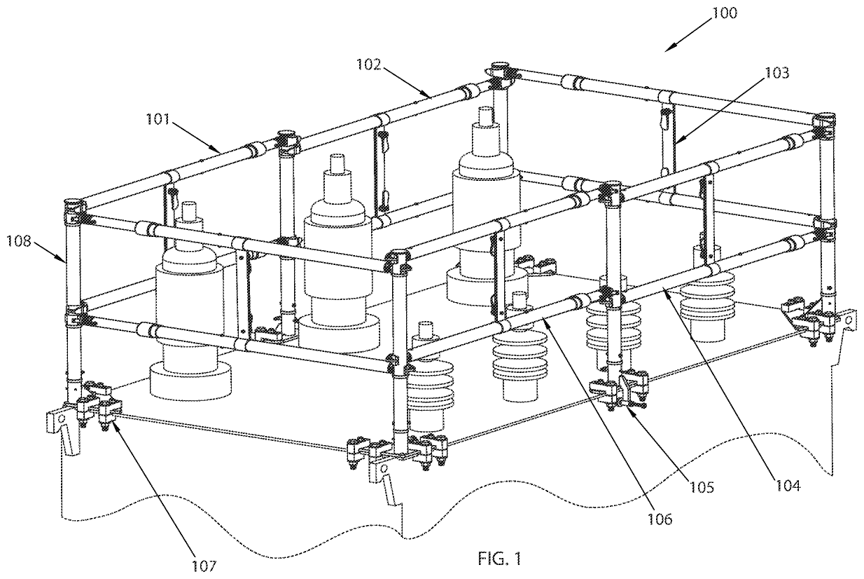

In many respects the present railing system is similar to the prior art system shown in FIG. 1.

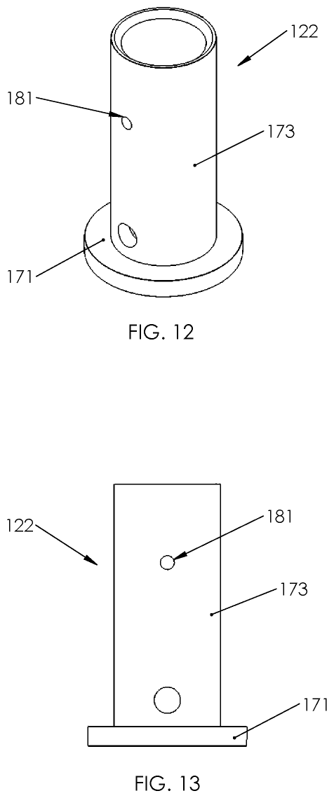

However, in the present railing system 14 the railing posts 124 are anchored using anchors 122 (FIG. 2) which are similar to the anchors 22A/22B discussed above and shown in FIG. 6, but, because they do not need to support diagonal members, lack the flange 61, have a smaller base plate, and only require a single stud for mounting to the transformer surface. Referring to FIGS. 12-13, anchor 122 has a round base plate 171, a socket 173 dimensioned to receive a lower end of a railing post, and a bore 181 through which the post can be pinned to the socket. The anchor 122 is installed in a manner similar to that shown in FIGS. 8B and 8D and described above with respect to those drawings. Only a single stud, disposed within the base of the socket, is required for installation of the anchors 122, due to the smaller base plate and lower load on the railing post.

These anchors facilitate installation of the railing system due to the simple installation described above in connection with the anchors 22A/22B. Safety is also enhanced, as the anchors can be installed without the operator being required to reach over the edge of the transformer surface 11 as was the case with the C-clamp type anchors shown in FIG. 1.

The railing system 14 also differs from the prior art system shown in FIG. 1 due to the inclusion of a sliding gate 85. Sliding gate 85, shown in detail in FIGS. 10 and 10A, allows an opening in the railing to be provided through which the person being evacuated can be lowered, eliminating the need to lift the person over the railing. It is desirable that the gate slide, rather than swing, both to conserve space and for safety reasons (a swinging gate could accidentally swing open if not secured in place).

Referring to FIGS. 10 and 10A, the sliding gate 85 includes a pair of horizontal cylindrical sliding members 87 that are telescopically mounted in cylindrical sheath members 89, which have an inner diameter that is slightly larger than the outer diameter of the sliding members 87, e.g., by about 0.20 to 0.30 inch (5.0 to 7.6 mm). Fittings in the assembly (not shown) are configured to tighten the clearance to less than 0.1 inch (2.5 mm), e.g., 0.05 inch (1.3 mm) to reduce the play between the tubes. The sheath members 89 are secured to and supported by adjacent horizontal railing members 91. A vertical member 93 joins the sliding members at their ends and provides an area to be grasped during opening and closing of the gate. A clamp 95 is provided on the vertical member 93 to allow the gate to be secured in the closed position (FIG. 10). The clamp 95 does not need to be particularly secure since the gate will not open when an outward force is exerted on it (e.g., a falling person) due to its sliding rather than swinging nature.

### Other Embodiments

A number of embodiments have been described. Nevertheless, it will be understood that various modifications may be made without departing from the spirit and scope of the disclosure.

For example, while a foldable frame is discussed above and shown in the drawings, if desired the rescue system may be permanently mounted, or removable but not foldable. Similarly, while the use of the rescue system discussed above is as a removable and deployable system, a user's safety protocol may be to leave the rescue system deployed at all times to facilitate a shorter evacuation time.

Accordingly, other embodiments are within the scope of the following claims.

What is claimed is:

1. A rescue system for evacuating an incapacitated person from an elevated area, the system comprising:
a frame configured to be mounted on a pair of vertical posts extending upwardly from a surface of the elevated area, the posts defining a plane, wherein at least a portion of the frame is cantilevered out from the plane of the posts, and
a lowering system supported by the cantilevered portion of the frame, the lowering system being configured to allow a rescuer to lower the incapacitated person by rope from the elevated area.

2. The rescue system of claim 1 further comprising a pair of frame tension lines each having a first end configured to be attached to the frame at an upper end of the vertical posts and a second end configured to be anchored to the surface of the elevated area.

3. The rescue system of claim 1 wherein the lowering system comprises a rope having a first end configured to be fixedly attached to the frame.

4. The rescue system of claim 3 wherein the lowering system further comprises a winch.

5. The rescue system of claim 1 wherein the frame includes a horizontal assembly, a first end of which is mounted at upper ends of the vertical posts and a second, opposite end of which is cantilevered out therefrom, and a pair of diagonal members that extend from corners of the second end to lower ends of the vertical posts.

6. The rescue system of claim 3 wherein the lowering system further includes a plurality of pulley carabiners.

7. The rescue system of claim 6 wherein the frame is constructed of non-conductive material.

8. The rescue system of claim 1 wherein lower ends of the posts are removably mounted in anchors secured to the surface of the elevated area.

9. The rescue system of claim 1 wherein the frame comprises a plurality of members that are detachably joined to each other.

10. A safety system for use in an elevated work area, the safety system comprising:
(a) a railing system comprising:
a plurality of posts anchored to a surface of the elevated work area;
a plurality of rails extending between the posts to define a guard rail assembly; and
a sliding gate in the guard rail assembly providing, when open, an open area for access to the elevated work area from below; and
(b) a rescue system comprising:
a frame configured to be mounted on a pair of vertical posts extending upwardly from a surface of the elevated area, the posts defining a plane, wherein at least a portion of the frame is cantilevered out from the plane of the posts, and
a lowering system supported by the cantilevered portion of the frame, the lowering system being configured to allow a rescuer to lower the incapacitated person by rope from the elevated area.

11. The safety system of claim 10 wherein the sliding gate comprises a pair of horizontal cylindrical sliding members that are telescopically mounted in cylindrical sheath members.

12. The safety system of claim 10 wherein the rescue system further comprises anchors secured to the elevated work area, each anchor comprising a base plate, an elongated socket extending upwardly from the base plate, and a flange extending laterally from the socket.

13. The safety system of claim 12 wherein the socket is dimensioned to receive the lower end of one of the vertical posts of the rescue system and includes a through bore configured to receive a pin to secure the post in the socket.

14. The safety system of claim 13 wherein the flange includes a bore configured to allow mounting of the diagonal members of the frame to the anchor.

15. A method of evacuating a person from an elevated work area, the method comprising:
deploying a rescue system that includes a frame having a portion that is cantilevered out from an edge of the work area and defines an opening through which the person can pass, and a lowering system supported by the cantilevered portion of the frame,
securing the person to a portion of the lowering system; and
utilizing the lowering system to lower the person from the elevated work area.

16. The method of claim 15 wherein utilizing the lowering system comprises operating a winch that forms part of the lowering system.

17. The method of claim 15 wherein deploying the rescue system includes anchoring the frame to a surface of the elevated work area.

18. The method of claim 17 wherein deploying the rescue system includes attaching the frame to anchors that have been pre-installed on the surface prior to the evacuation.

19. The method of claim 15 wherein the opening is in a railing system that is disposed along the edge of the work area, the opening is normally closed by a sliding gate, and the method further comprises the step of opening the sliding gate.

20. The method of claim 15 wherein utilizing the lowering system includes feeding a rope attached to the person through a double fall pulley mechanism.
